(19) United States
(12) Patent Application Publication
(10) Pub. No.: US 2016/0306602 A1
(43) Pub. Date: Oct. 20, 2016

(54) CHOREOGRAPHY-CREATION AID METHOD, INFORMATION PROCESSING APPARATUS, AND COMPUTER -READABLE RECORDING MEDIUM

(71) Applicant: FUJITSU LIMITED, Kawasaki-shi (JP)

(72) Inventors: Yoshitoshi Kurose, Kawasaki (JP); Kiyoshi Ryokai, Tama (JP)

(21) Appl. No.: 15/098,888

(22) Filed: Apr. 14, 2016

(30) Foreign Application Priority Data
Apr. 17, 2015 (JP) 2015-085378

(51) Int. Cl. G06F 3/14; H04W 4/02

(52) U.S. Cl. CPC G06F 3/1446; H04W 4/023

(57) ABSTRACT

A choreography-creation aid method includes: receiving, from a terminal that is present in a certain area, information that enables identifying a location of the terminal; determining, for each of sections obtained by dividing the certain area into two or more, whether a number of terminals that is calculated from the received information that enables identifying the location is greater than a certain number, by a processor; and transmitting, to at least a part of terminals out of the terminals present in a first section for which the number of terminals is determined to be greater than the certain number, a request for moving to a second section for which the number of terminals is not determined to be greater than the certain number.

### CROSS-REFERENCE TO RELATED APPLICATION

This application is based upon and claims the benefit of priority of the prior Japanese Patent Application No. 2015-085373, filed on Apr. 17, 2015, the entire contents of which are incorporated herein by reference.

### FIELD

The embodiments discussed herein are related to a choreography-creation aid method, an information processing apparatus, and a computer-readable recording medium.

### BACKGROUND

In a place like a stadium where a great number of people gather, a kind of mass games or mass gymnastics that a large number of spectators (participants) perform in collaboration includes choreography. In this choreography, characters and images are represented by regarding the terminals of the participants in their respective seats as pixels, for example. A related art example is described in Japanese Laid-open Patent Publication No. 2004-264735.

The choreography, however, is collaborative work of a large number of participants, and thus it needs deliberate preparation in advance and performing it easily is difficult. For example, to neatly present the choreography, it is important to place the participants such, that no defect arises in an image it represents. It is not an easy task, in the choreography by a large number of participants, to direct the placement of the participants in this manner.

### SUMMARY

According to an aspect of the embodiments, a choreography-creation aid method includes: receiving, from a terminal that is present in a certain area, information that enables identifying a location of the terminal; determining, for each of sections obtained by dividing the certain area into two or more, whether a number of terminals that is calculated from the received information that enables identifying the location is greater than a certain number, by a processor; and transmitting, to at least a part of terminals out of the terminals present in a first section for which the number of terminals is determined to be greater than the certain number, a request for moving to a second section for which the number of terminals is not determined to be greater than the certain number.

The object and advantages of the invention will be realized and attained by means of the elements and combinations particularly pointed out in the claims.

It is to be understood that both the foregoing general description and the following detailed, description are exemplary and explanatory and are not restrictive of the invention.

BRIEF DESCRIPTION OF DRAWINGS

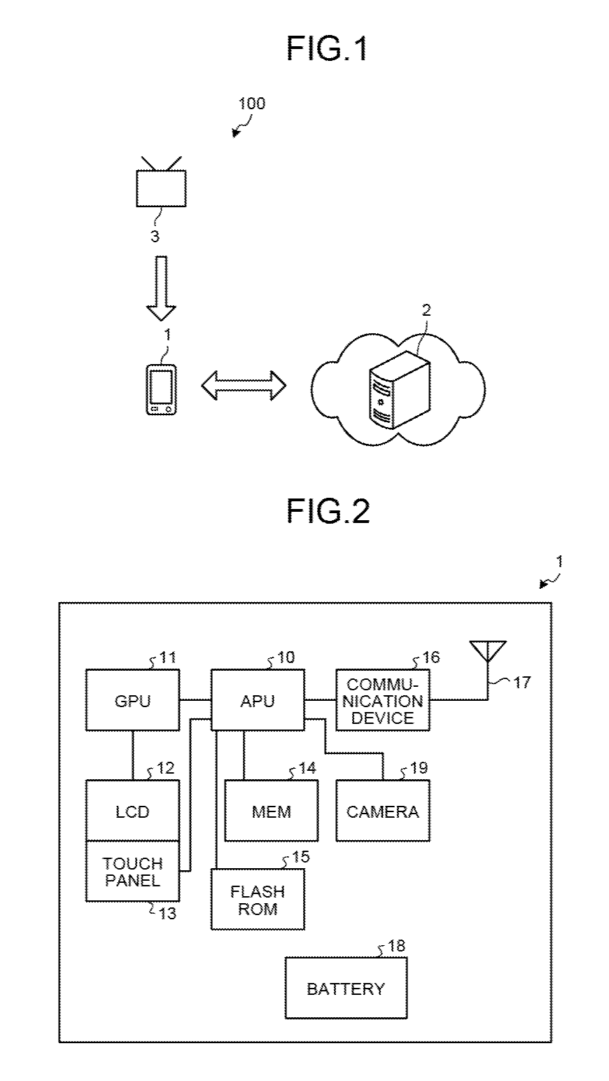

FIG. 1 is an explanatory diagram illustrating one example of a choreography-creation aid system according to a first embodiment;

FIG. 2 is a block diagram illustrating an example of a configuration of a terminal device in the first embodiment;

FIG, 3 is a block diagram illustrating an example of a configuration of a server in the first embodiment;

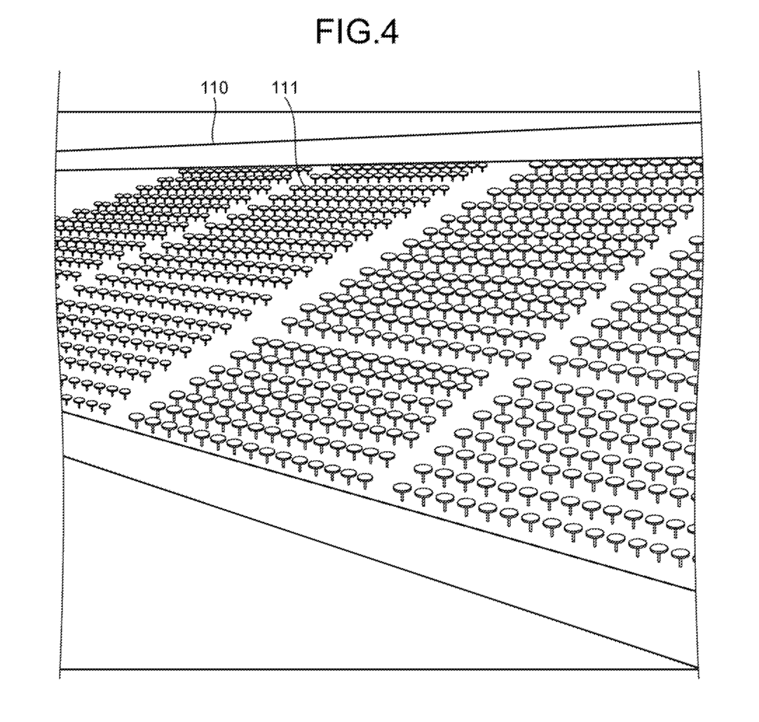

FIG. 4 is a diagram for explaining a stadium;

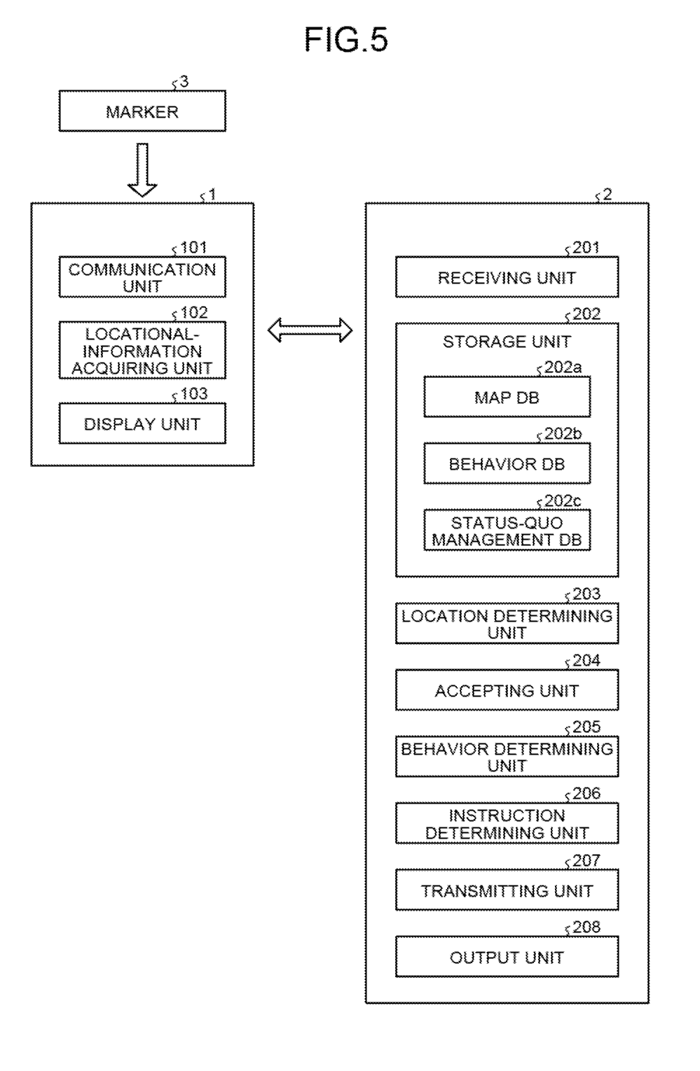

FIG. 5 is a block diagram illustrating an example of a functional configuration of the choreography-creation aid system in the first embodiment;

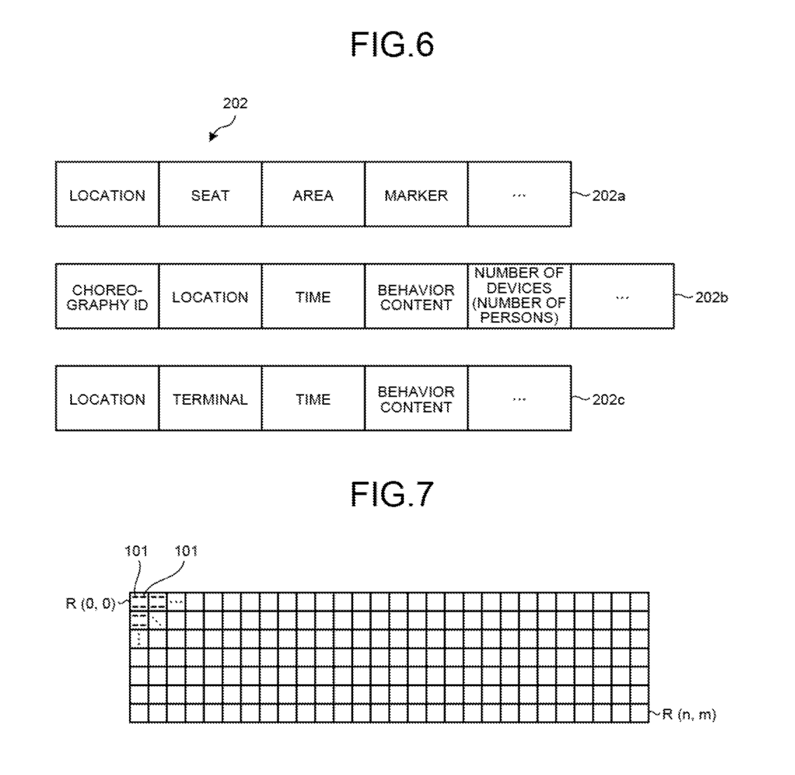

FIG. 6 is a diagram for explaining content of DBs;

FIG. 7 is a diagram for explaining areas in the stadium;

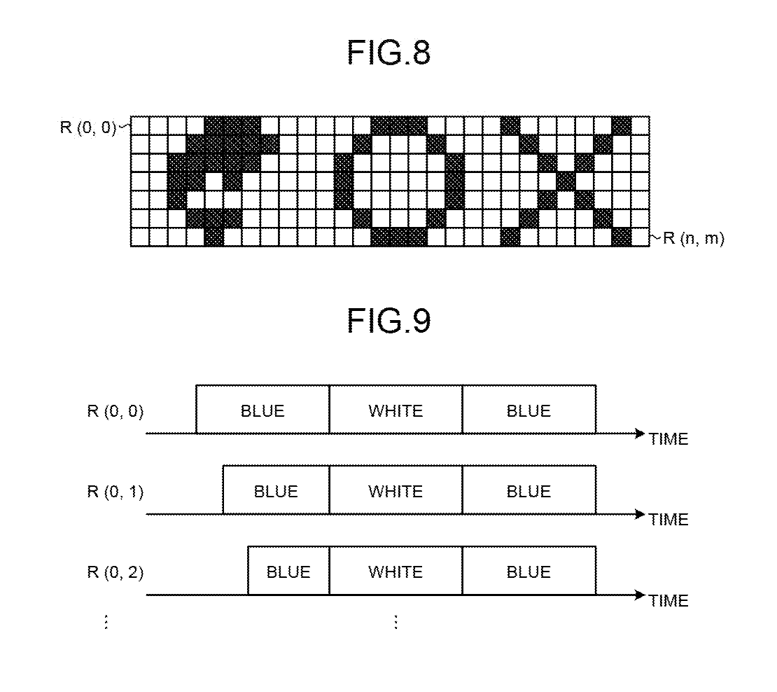

FIG. 8 is a diagram for explaining choreography;

FIG. 9 is a diagram for explaining behavior content;

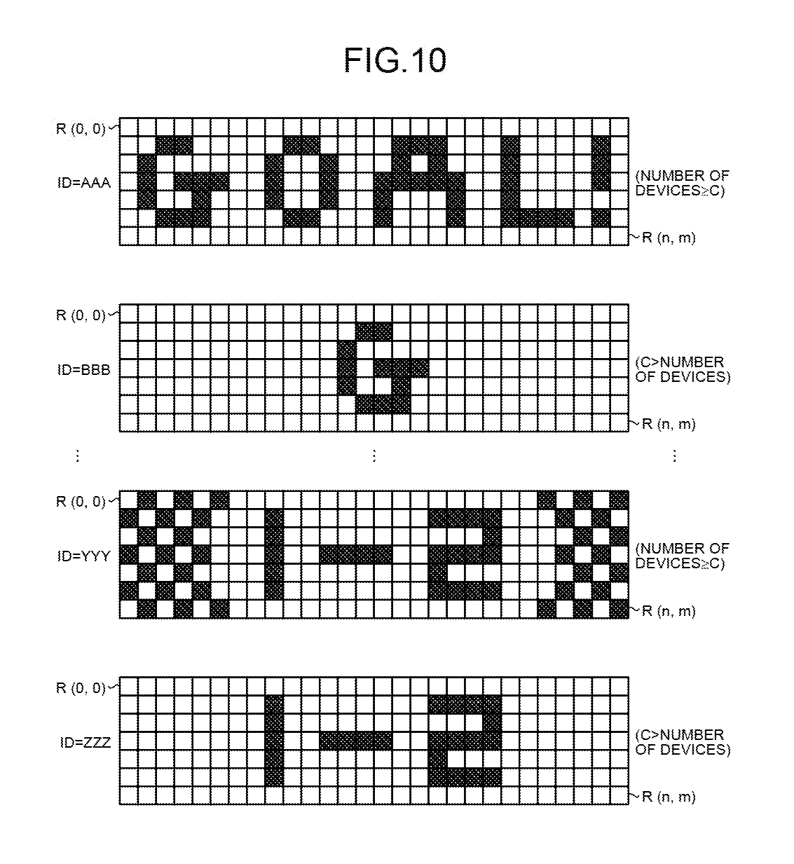

FIG. 10 is a diagram illustrating content of a behavior DB;

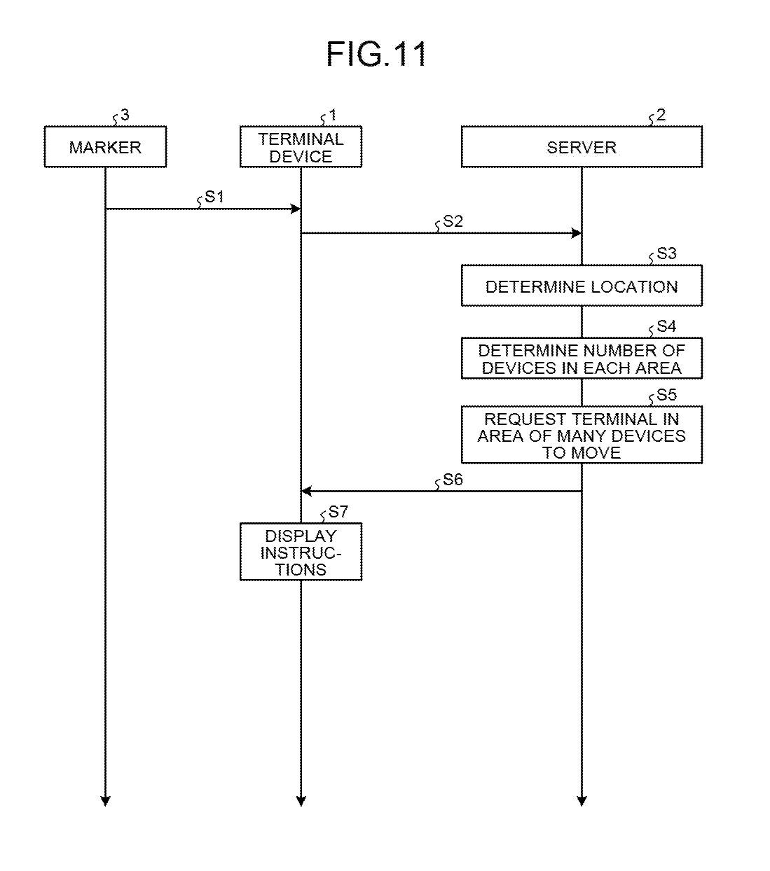

FIG. 11 is a ladder chart illustrating an example of operation of the choreography-creation aid system in the first embodiment;

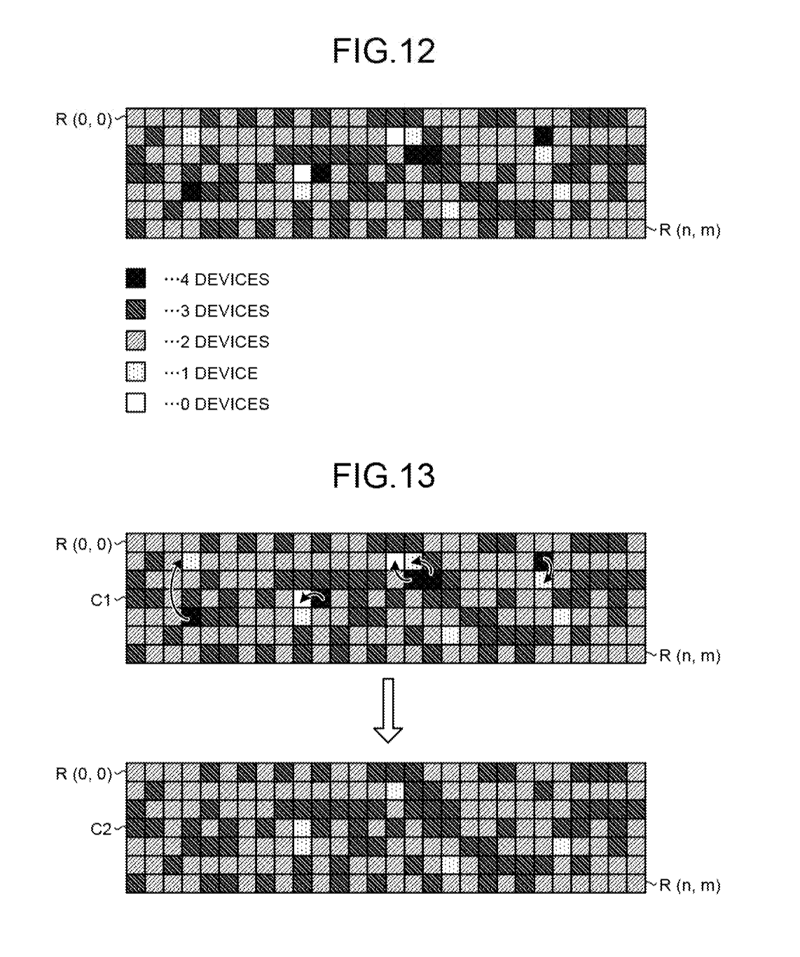

FIG. 12 is a diagram illustrating the number of devices in each area;

FIG. 13 is a diagram for explaining moving of terminal devices;

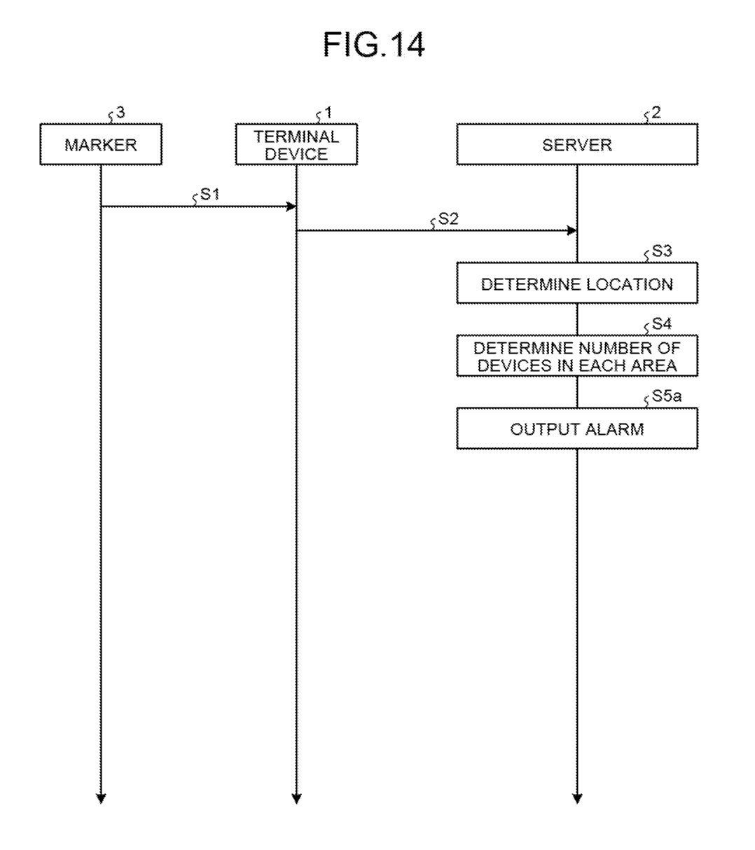

FIG. 14 is a ladder chart illustrating an example of operation of the choreography-creation aid system according to a modification;

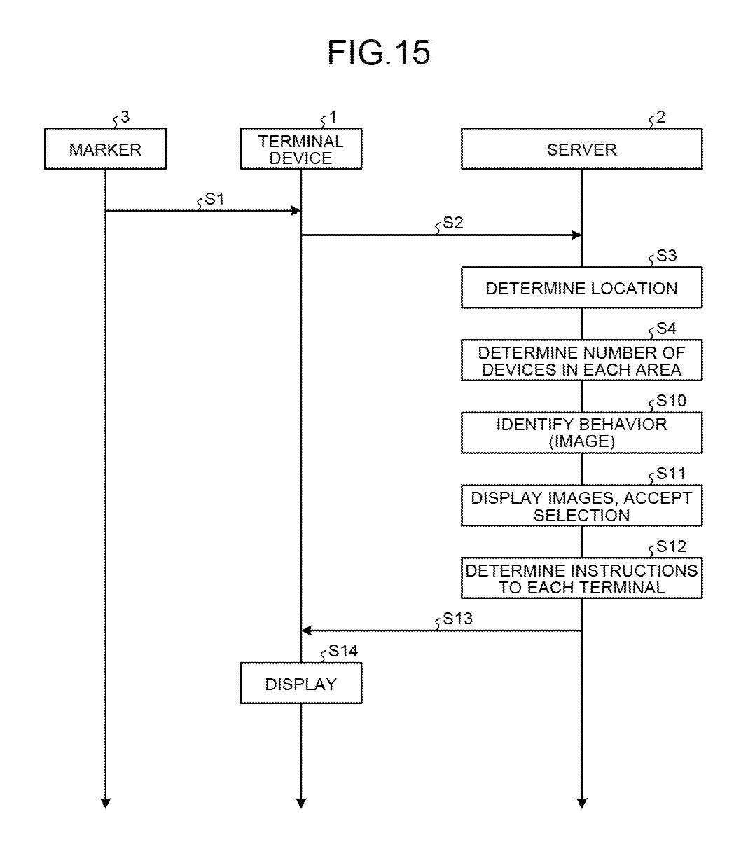

FIG. 15 is a ladder chart illustrating an example of operation of a choreography-creation aid system according to a second embodiment;

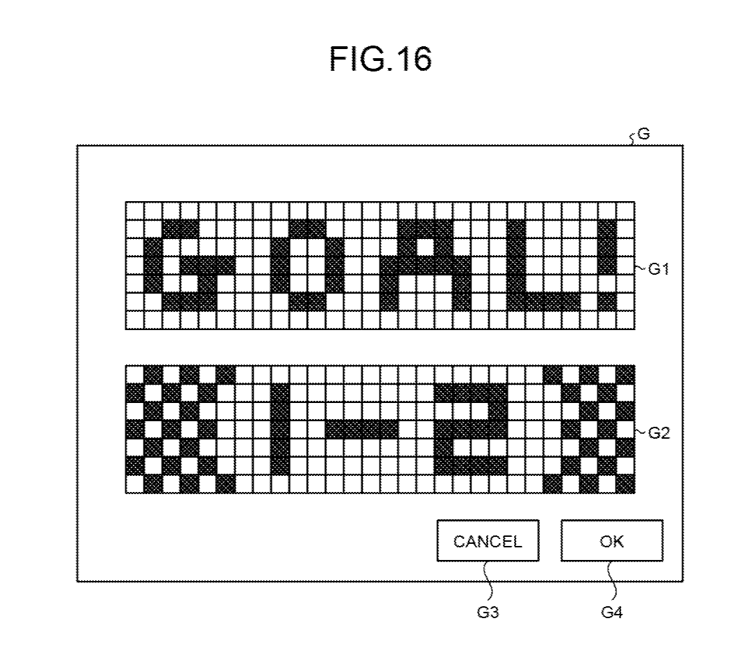

FIG. 16 is a diagram for explaining a display screen;

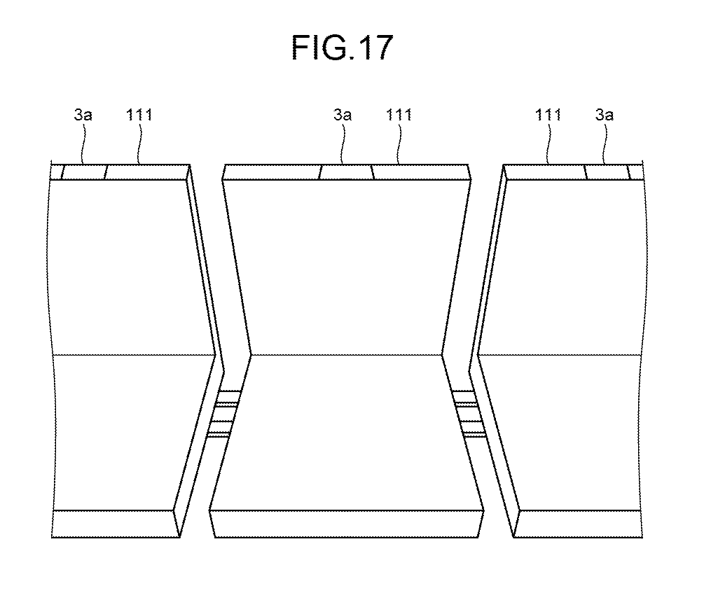

FIG. 17 is a diagram for explaining markers according to a third embodiment; and

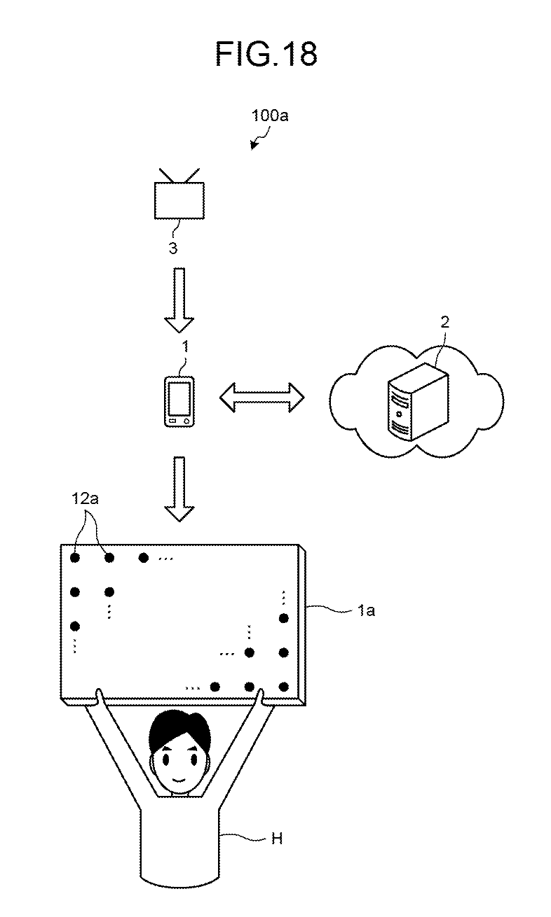

FIG. 18 is an explanatory diagram illustrating one example of a choreography-creation aid system according to a fourth embodiment.

### DESCRIPTION OF EMBODIMENTS

Preferred embodiments will be explained with reference to accompanying drawings. In the embodiments, constituents having identical functions are given identical reference signs, and their redundant explanations are omitted. The choreography-creation aid method, the choreography-creation aid program, and the information processing apparatus described in the following embodiments illustrate mere examples, and are not intended to limit the embodiments. The following embodiments may be combined appropriately as far as it does not cause any inconsistency.

### [a] First Embodiment

FIG. 1 is an explanatory diagram illustrating one example of a choreography-creation aid system 100 according to a first embodiment. As illustrated in FIG. 1, the choreography-creation aid system 100 includes a terminal device 1, a server 2, and a marker 3.

The terminal device 1 is a portable terminal that a user (participant) who participates in choreography possesses and uses, and is a smartphone and a tablet device, for example. In the first embodiment, the choreography is assumed to be carried out in a stand of a stadium in which seats are placed. For example, the choreography is performed in the stand to encourage players when the users watch a sport event at the seats.

FIG. 2 is a block diagram illustrating an example of a configuration of the terminal device 1 in the first embodiment, As illustrated in FIG. 2, the terminal device 1 includes an APU 10, a GPU 11, an LCD 12, a touch panel 13, an MEM 14, a flash ROM 15, a communication, device 16, an antenna 17, a battery 18, and a camera 19.

The application processor unit (APU) 10 loads programs stored in the flash ROM 15 and the like onto the MEM 14 and executes them in sequence, and thereby controls the operation of a whole of the terminal device 1. The graphics processing unit (GPU) 11 controls, under the control of the APU 10, display of the LCD 12.

The liquid crystal display (LCD) 12 is an output interface that, displays, under the control of the GPU 11, a variety of information on a screen. The touch panel 13 is arranged overlapping the LCD 12, and is an input interface that receives touch operation and others of the user and inputs a variety of information and commands.

The memory (MEM) 14 provides a work area when the APU 10 executes the programs. The flash read-only memory (ROM) 15 stores therein the programs that the APU 10 executes and various setting information.

The communication device 16 performs, under the control of the APU 10, radio communication via the antenna 17. For example, the communication device 16 executes, in addition to the radio communication of long term evolution (LTE) standard and Wi-Fi standard, near field communication (NFC) such as Bluetooth (registered trademark) low energy (BTLE) standard. The battery 18 is a power source that supplies electrical power to the whole of the terminal device 1. The camera 19 is a digital camera that takes, under the control of the AFU 10, a still image or a moving image.

The server 2 is an information processing apparatus such as a personal computer (PC), for example, and provides a service of aiding the creation of choreography. Specifically, the server 2 receives information that enables identifying a location from the terminal device 1 of each user participating in the choreography, and identifies the location of each user. The server 2 then transmits, to the terminal device 1, instructions of moving depending on the location of each user and instructions of behavior concerning the choreography (the details thereof will be described later).

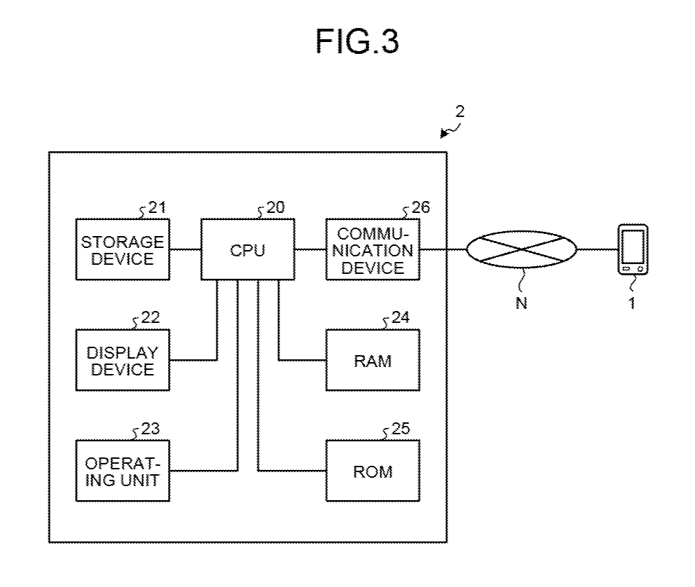

FIG. 3 is a block diagram illustrating an example of a configuration of the server 2 in the first embodiment. As illustrated in FIG. 3, the server 2 includes a CPU 20, a storage device 21, a display device 22, an operating unit 23, a RAM 24, a ROM 25, and a communication device 26.

The central processing unit (CPU) 20 loads programs stored in the storage device 21 and others onto the RAM 24 and executes them in sequence, and thereby controls the operation of a whole of the server 2. The storage device 21 is a hard disk drive (HDD), for example, and stores therein the programs that the CPU 20 executes, various setting information, information acquired from the terminal device 1, and others.

The display device 22 is a display such as an LCD and displays, under the control of the CPU 20, a variety of information on a screen, for example. The operating unit 23 is an input interface such as a keyboard and a mouse, and receives operating input of a user (an operator of the server 2), for example.

The random access memory (RAM) 24 provides a work area when the CPU 20 executes the programs. The read only memory (ROM) 25 stores therein a basic program that the CPU 20 executes at the time of starting up the server 2.

The communication device 26 performs, under the control of the CPU 20, communication via a communication network N such as a local area network (LAM) and the Internet. The server 2 performs communication via the communication network N, thereby transmitting and receiving data with the terminal device 1 by radio communication via an access point (AP, not depicted) on the communication network N.

The marker 3 is a radio beacon arranged for each given location in a place such as a stadium where the choreography is carried out. Specifically, the marker 3 broadcasts information such as identification data (ID) that is assigned to the marker itself by near field communication using BTLE standard.

FIG. 4 is a diagram for explaining a stadium 110. As illustrated in FIG. 4, in a stadium 110 where the choreography is carried out, a plurality of seats 111 are arranged. The marker 3 is arranged for each seat 111 or for each area composed of a plurality of seats 111. The terminal device 1 receives information (for example, the ID) broadcast from the nearby marker 3, and as the information that enables identifying the location of the terminal device 1, transmits to the server 2 the received information, and the radio wave intensity at the time of receiving. The server 2 identifies, based on the information transmitted from the terminal device 1, the location of the terminal device 1.

As just described, in the first embodiment, the location of the terminal device 1 is identified in an indoor global positioning system (GPS) by radio determination using the marker 3. As for identifying the location of the terminal device 1 in the stadium 110, it may be radio determination using an access point of a wireless LAN. The method of identifying the location is not specifically limited as long as it is a method that can identify where the terminal device 1 is present in a place where the choreography is carried out.

FIG. 5 is a block diagram illustrating an example of a functional configuration of the choreography-creation aid system 100 in the first embodiment. As illustrated in FIG. 5, the terminal device 1 includes, as the functional configuration implemented by the APU 10 executing the programs, a communication unit 101, a locational-information acquiring unit 102, and a display unit 103. The server 2 includes, as the functional configuration implemented by the CPU 20 executing the programs, a receiving unit 201, a storage unit 202, a location determining unit 203, an accepting unit 204, a behavior determining unit 205, an instruction determining unit 206, a transmitting unit 207, and an output unit 208.

The communication unit 101 performs radio communication with the marker 3 and the server 2 by the communication device 16. Specifically, the communication unit 101 receives information broadcast from the marker 3 by near field communication using BTLE standard and others. The communication unit 101 further performs data communication with the server 2 via the communication network N by radio communication of LTE standard, Wi-Fi standard, and others.

The locational-information acquiring unit 102 acquires, based on the information that the communication unit 101 received, the information that enables identifying the location, of the terminal device 1. Specifically, the locational-information acquiring unit. 102 acquires the information (ID) received from the marker 3, and the radio wave intensity that was detected by the communication device 16 at the time of receiving. The acquired information is transmitted to the server 2 by the communication unit 101 together with information indicative of the terminal device 1 (for example, a terminal ID). The acquisition of the information that enables identifying the location of the terminal device 1 and the transmission of the acquired information to the server 2 are performed at a certain period (for example, 10 seconds).

The display unit 103 performs, based on the data received by the communication unit 101 from the server 2, display on the LCD 12. Specifically, the display unit 103 displays instructions of moving that, was transmitted from the server 2 on the LCD 12. The display unit 103 further displays instructions of behavior concerning the choreography transmitted from the server 2 on the LCD 12.

The receiving unit 201 receives the information transmitted from the terminal device 1 by the communication device 26. Specifically, the receiving unit 201 receives the information that enables identifying the location of the terminal device 1 transmitted from the terminal device 1, and outputs it to the location determining unit 203.

The storage unit 202 stores therein a map database (DB) 202a, a behavior DB 202b, and a status-quo management DB 202c. The map DB 202a is a database that manages map information about the stadium 110 such as the location of the seat 111, the location of a certain area, the location of the marker 3, and others. The behavior DB 202b is a database that manages a variety of information for each program performed as choreography. The status-quo management DB 202c is a database that manages information indicative of the status quo of the choreography-creation aid system 100 such as the current location of the terminal device 1, and the information indicative of behavior in the choreography that is currently determined for each location (the seat 111) in the stadium 110.

FIG. 6 is a diagram for explaining the content of the DBs. As illustrated in FIG. 6, the map DB 202a retains, for each location in the stadium 110, the information such as “location,” “seat,” “area,” and “marker.” The “location” is the information indicative of the location in the stadium 110, and is a position coordinate uniquely assigned in the stadium 110, for example. The “seat” is the information indicative of the seat 111 placed at the coordinate position indicated by “location,” and is a seat number of the seat 111, for example. The “area” is the information indicative of an area that the stadium 110′ is sectioned, and is identification information on the area to which the coordinate position indicated by “location” belongs, for example. The “marker” is the information indicative of the marker 3 placed at the coordinate position indicated by “location,” and is the ID of the marker 3, for example.

FIG. 7 is a diagram for explaining the areas in the stadium 110. As illustrated in FIG. 7, in the first embodiment, the stand in the stadium 110 in which the seats 111 are placed is sectioned into areas R (0, 0) to R (n, m) for the seats 111 of 2×2=4 seats each. By sectioning the stand in such a manner,, in “area” of the map DB 202a, any one of the areas R (0, 0) to R (n, m) is stored.

While the situation in which the stand where the seats 111 are placed is sectioned as areas is illustrated in the first embodiment, the definition of the areas is not limited to the foregoing. For example, the areas may be sectioned for the seats 111 of 4×4=16 seats each. The shape of the area can be determined as desirable, and may be in a rectangular shape of 2×8=16 seats. When the choreography is performed on a stadium ground, the areas may be the sectioned stadium ground.

The behavior DB 202b retains, for each program of choreography (an image represented by the choreography), information such as “choreography ID,” “location,” “time,” “behavior content,” and “the number of devices (the number of persons).” The “choreography ID” is the identifying information about choreography, and is the ID=AAA, BBB, . . . ZZZ assigned for each program of choreography, for example.

The “location,” “time,” and “behavior content” in the behavior DB 202b are the information indicative of behavior (role) to represent an image by choreography for each location such as a seating position, an area, and a coordinate position in the stadium 110.

FIG. 8 is a diagram for explaining choreography. As illustrated in FIG. S, in the choreography in the first embodiment, by altering the behavior content for each of the areas R (0, 0) to R (n, m), an image such as pictures and characters is reproduced. The unit (pixel unit) of altering the behavior content may be of not only each area but also each seat 111, and is not specifically limited.

FIG. 9 is a diagram for explaining the behavior content. As illustrated in FIG. 9, the information on “location,” “time,” and “behavior content” is the one that indicates, for each time, the behavior in the respective areas of R (0, 0), R (0, 1), and so forth. For example, when the LCD 12 of the terminal device 1 is regarded as a pixel, in the area indicated in “location,” for each time from the start to the end of choreography indicated in “time,” the display content (such as blue and white) on the LCD 12 is indicated in “behavior content.”

The “the number of devices (the number of persons)” in the behavior DB 202b is the information indicative of the number of terminal devices 1 (the number of users) needed to perform choreography. For example, “the number of devices (the number of persons)” is the information about the number of the terminal devices 1 needed in the respective areas at the time of performing the choreography.

FIG. 10 is a diagram illustrating the content of the behavior DB 202b. As illustrated in FIG. 10, as for the images to reproduce in choreography, even for representing a goal in soccer, for example, there are “GOAL!” having many characters and being complex and “G” having less characters and being simple. Also; on the notation of scores, there are decorative complex score notation and simple score notation. As for “GOAL!” having many characters and for the decorative complex score notation, when the number of the terminal devices 1 in each area is small, there may be cases in which it is difficult to reproduce the image neatly. Consequently, for the choreography that reproduces a complex image, by taking the number of devices≧C in “the number of devices (the number of persons),” a lower limit (C) of the number of devices needed in each area may be defined in advance.

The status-quo management DB 202c retains, for each location in the stadium 110, the information concerning the status quo such as “location,” “terminal,” “time,” and “behavior content.” The “location” is the information indicative of the location in the stadium 110, and is a position coordinate uniquely assigned in the stadium 110, for example. The “terminal” is the information indicative of the terminal device 1 currently present at the coordinate position indicated in “location,” and is a terminal ID of the terminal device 1, for example. In this “terminal,” the information on each terminal device 1 the location of which is determined by the location determining unit 203 is stored. The “time” and “behavior-content” are the information indicative of the behavior (role) in choreography currently determined at the coordinate position indicated in “location.” In these “time” and “behavior content,” the information on the behavior corresponding to the location in the choreography that is determined by the behavior determining unit 205 is stored.

The location determining unit 203 refers, based on the information that enables identifying the location of the terminal device 1 that is transmitted from the terminal device 1 together with the terminal ID, to the map DB 202a and identifies the current location of the terminal device 1. The location determining unit 203 stores the information indicative of the identified current location of the terminal device 1 into the status-quo management DB 202c.

The accepting unit 204 accepts various operations of the user (the operator of the server 2) from the operating unit 23. For example, the accepting unit 204 accepts a selection operation when a program to perform is selected out of a plurality of programs of choreography.

The behavior determining unit 205 determines, based on the current location of each of the terminal devices 1 managed by the status-quo management DB 202c, a program to perform out of the programs of choreography preset in the behavior DB 202b. The behavior determining unit 205 stores the information on “location,” “time,” and “behavior content” of the determined program of choreography into the status-quo management DB 202c.

The instruction determining unit 206 determines, based on the information stored in the status-quo management DB 202c, instructions for the respective terminal devices 1. Specifically, the instruction determining unit 206 refers to the status-quo management DB 202c for the current location of the terminal device 1 identified by the location determining unit 203 and determines the number of the terminal devices 1 in each area. The instruction determining unit 206 then determines, based on the determination result, instructions of moving depending on the location of the respective users and instructions of behavior concerning the choreography. The function as a determining unit that determines the number of the terminal devices 1 in each area may be provided not only on the instruction determining unit 206 but also on the location determining unit 203. For example, the location determining unit 203 may determine, based on the current location of each of the terminal devices 1 managed in the status-quo management DB 202c, the number of the terminal devices 1 in the respective areas and store the determination result of each area into the status-quo management DB 202c.

The transmitting unit 207 transmits a variety of information to the terminal device 1 by the communication device 26. For example, the transmitting unit 207 transmits the instructions for the respective terminal devices 1, which are determined by the instruction determining unit 206, to the corresponding terminal devices 1 by the communication device 26.

The output unit 208 outputs a variety of information to the display device 22. For example, based on the current location of each terminal device 1 stored in the status-quo management DB 202c, the output unit 208 displays a warning (an alarm) on the display device 22 when there is an area for which the number of the terminal devices 1 is below a certain number.

FIG. 11 is a ladder chart illustrating an example of operation of the choreography-creation aid system 100 in the first embodiment. As illustrated in FIG. 11, the communication unit 101 of the terminal device 1 receives the information broadcast from the marker 3 (S1). The locational-information acquiring unit 102 of the terminal device 1 acquires, based on the information the communication unit 101 has received, the information that enables identifying the location of the terminal device 1 (the ID of the marker 3 and the radio wave intensity of receiving). The communication unit 101 of the terminal device 1 transmits to the server 2 the ID of the marker 3 and the radio wave intensity of receiving that the locational-information acquiring unit 102 has acquired (S2).

The location determining unit 203 of the server 2 refers, based on the information that enables identifying the location of the terminal device 1 received from the terminal device 1 (the ID of the marker 3 and the radio wave intensity of receiving), to the map DB 202a and determines the current location of the terminal device 1 (S3). The location determining unit 203 stores the information indicative of the determined current location of the terminal device 1 into the status-quo management DB 202c.

Specifically, the location determining unit 203 refers, based on the ID of the marker 3 included in the information that enables identifying the location of the terminal device 1, to the map DB 202a and obtains the current location of the marker 3. The location determining unit 203 then obtains, based on the radio wave intensity included in the information that enables identifying the location of the terminal device 1, a distance of the terminal device 1 with respect to the obtained location of the marker 3, and determines the location of the terminal device 1, For example, when the locations of a plurality of the markers 3 and the distances thereto are obtained for the terminal device 1, the location of the terminal device 1 can be determined by a triangulation method.

The instruction determining unit 206 of the server 2 refers to the information indicative of the current location of the terminal device 1 stored in the status-quo management DB 202c and determines the number of devices in each area (S4). Specifically, the instruction determining unit 206 obtains, based on the information indicative of the current location of the terminal device 1 stored in the status-quo management DB 202c, the number of the terminal devices 1 in each area. The instruction determining unit 206 then determines whether the number of the terminal devices 1 in each area is equal to or greater than a certain number.

FIG. 12 is a diagram illustrating the number of devices in each of the areas (R (0, 0) to R (n, m)). As illustrated in FIG. 12, by referring to the information indicative of the current location of the terminal device 1 stored in the status-quo management DB 202c, the instruction determining unit 206 obtains the number of the terminal devices 1 in the areas R (0, 0) to R (n, m).

The instruction determining unit 206 determines whether the number of the terminal devices 1 in the areas R (0, 0) to R (n, m) is equal to the certain number (for example, four). While the number of devices as the criterion for the determination in each area has been defined as four in the first embodiment, a desired number of devices may be defined. For example, because the number of seats 111 in each area is 2×2=4, the number of devices as the criterion for the determination may be defined as two, which is an intermediate value. The instruction determining unit 206 may obtain an average number of devices in each area from the number of the terminal devices 1 in the whole areas and the number of areas, and define this average number of devices as the criterion of the determination.

The instruction determining unit 206 then determines, based on the determination result at S4, a request for moving to an area for which the number of devices is not determined to be equal to or greater than the certain number, as an instruction for the terminal devices 1 in the area for which the number of devices is greater (S5).

Specifically, the instruction determining unit 206 identifies, out of the areas R (0, 0) to R (n, m), the areas for which the number of the terminal devices 1 is equal to or greater than the certain number (for example, four). The instruction determining unit 206 then searches for an area, for which the number of devices is not determined to be equal to or greater than the certain number, out of the areas near the identified area, and defines an appropriate area as the area of destination. At this time, the instruction determining unit 206 may define, as a condition of the search, an area for which a moving distance is short and an area for which the number of the terminal devices 1 is smaller. The instruction determining unit 206 then selects at least one of the terminal devices 1 out of the area that has been identified by referring to the status-quo management DB 202c and determines, as the instruction to the terminal device a request for moving to the area of destination. While it is defined that the number of devices to select is one in the first embodiment, the number of devices to select may be two or greater.

Then, the transmitting unit 207 transmits the request for moving the terminal device 1 that has been determined at S5 to the corresponding terminal device 1 by the communication device 26 (S6). In the terminal device 1 that received the request for moving, the display unit 103 displays instructions based on the request for moving on the LCD 12 (S7). Specifically, the display unit 103 displays a screen guiding the user to the area of destination that is in the request for moving. Thus, the user can move to an area for which the number of participants is small (the number of the terminal devices 1 is small).

As in the foregoing, the server 2 receives, from the terminal device 1 that is present in a certain area (for example, the stadium 110), the information that enables identifying the location of the terminal device 1. The server 2 further determines, for the respective areas of R (0, 0) to R (n, m), whether the number of the terminal devices 1 calculated from the information that enables identifying the location that has been received is greater than the certain number. The server 2 further transmits, to at least a part of the terminal devices 1 out of the terminal devices 1 present in an area for which the number of devices is determined to be greater than the certain number, a request for moving to an area for which the number of devices is not greater than the certain number. Consequently, in the choreography-creation aid system 100, by the request for moving that has been transmitted, the moving of the users to the areas for which the number of devices is small is promoted, whereby the occurrence of defect in an image represented in the choreography can be suppressed easily.

FIG. 13 is a diagram for explaining the moving of the terminal devices 1. As illustrated in FIG. 13, by the display of instructions at S7, the moving of the terminal devices 1 is performed from the areas for which the number of the terminal devices 1 is greater than a certain number (for example, four) to the areas for which the number of devices is not determined to be greater than the certain number. In the example illustrated, moving is performed from the areas for which the number of the terminal devices 1 is four or greater to the nearby areas for which the number of devices is small. Consequently, without giving instructions to each user from the host of the choreography, for example, the moving of the terminal devices 1 to the areas for which the number of devices is small is promoted and the occurrence of defect in an image represented in the choreography can fee suppressed easily.

### Modification

FIG. 14 is a ladder chart illustrating an example of operation of the choreography-creation aid system 100 according to a modification. As illustrated in FIG. 14, in the modification, based on the determination result at S4, the output unit 208 performs an alarm output (S5a). Specifically, the output unit 208 displays a warning (an alarm) on the display device 22 when there is an area for which the number of the terminal devices 1 is below a certain number.

For example, when the number of the terminal devices 1 is small in the areas R (0, 0) to R (n, m), a defect may arise in a part of an image reproduced by choreography and thus there may be cases that it is difficult to reproduce the image clearly. Consequently, by outputting an alarm when there is an area for which the number of the terminal devices 1 is below the certain number, the user of the server 2 can recognize in advance that it is difficult to carry out clear choreography.

### [b] Second Embodiment

FIG. 15 is a ladder chart illustrating an example of operation of the choreography-creation aid system 100 according to a second embodiment. As illustrated in FIG. 15, in the second embodiment, the behavior determining unit 205 identifies, based on the determination result at S4, an image that matches a condition of “the number of devices” out of the programs (images) of choreography preset in the behavior DB 202b (S10).

Specifically, the behavior determining unit 205 extracts, based on the number of the terminal devices 1 in each area determined at S4, the programs that are appropriate to “the number of devices (the number of persons)” in the behavior DB 202b out of the programs of choreography in the behavior DB 202b. For example, when the number of the terminal devices 1 in each area is two or greater, out of the programs in the behavior DB 202b, the ones for which the lower limit (C) of the number of devices in “the number of devices (the number of persons)” is two or smaller are extracted.

Consequently, out of a plurality of programs of choreography, the programs depending on the number of the terminal devices 1 in each area can be extracted. For example, when the number of the terminal devices 1 in each area is small, simple programs that are reproducible even with a small number of devices can be extracted.

The output unit 208 then displays on the display device 22 images that the behavior determining unit 205 has identified. The accepting unit 204 accepts an operation of selecting an image to be carried out in choreography out of the images displayed on the display device 22 (S11). Consequently, the user of the server 2 can select an image that satisfies the condition of the number of the terminal devices 1 in each area.

FIG. 16 is a diagram for explaining a display screen G. As illustrated in FIG. 16, the output unit 208 displays on the display screen G of the display device 22 a list of images G1 and G2 that the behavior determining unit 205 has identified. Specifically, on the images G1 and G2 that the behavior determining unit 205 has identified, the output unit 208 reads out “location,” “time,” and “behavior content” in the behavior DB 202b, generates image data to be displayed in reduction on the display screen G, and displays it on the display device 22. As one example, the output unit 208 generates, based on “location,” “time,” and “behavior content,” graphics interchange format (GIF) data the image of which changes with the lapse of time, and displays it on the display device 22. The accepting unit 204 accepts, as the selection operation of images to be carried out in choreography, the selection of the images G1 and G2 and the operation of operation buttons G3 and G4 on the display device 22, from the operating unit 23.

Then, the behavior determining unit 205 determines the image, which has been selected at S11, as the one to be carried out in choreography, and stores the information on “location,” “time,” and “behavior content” of the determined image into the status-quo management DB 202c.

The instruction determining unit 206 then determines, based on the information stored in the status-quo management DB 202c, instructions of behavior of the choreography depending on the current location of the respective terminal devices 1 (S12). Specifically, the instruction determining unit 206 acquires, based on “location” and “terminal” in the status-quo management DB 202c, the current location of the respective terminal devices 1. The instruction determining unit 206 then refers to “time” and “behavior content” in the status-quo management DB 202c, and determines display content for representing the image of the choreography at the acquired current location of the terminal device 1. For example, based on the description in “time” and “behavior content,” display colors that are displayed on the LCD 12 of the terminal device 1, the timing of lighting thereof, and others are determined as the display content.

The transmitting unit 207 then transmits the display content that has been determined at S12 to the respective terminal devices 1 (S13). Specifically, the transmitting unit 207 transmits data indicative of the display content to the terminal device 1 indicated by the terminal ID in “terminal” in the status-quo management DB 202c.

In the terminal device 1 that received the data, the display unit 103 performs the display based on the display content on the LCD 12 (S14). For example, the display unit 103 lights up the LCD 12 at the timing and in the display color according to the display content. Consequently, the choreography-creation aid system 100 enables the choreography that represents characters and images to be carried out by regarding the display on the LCD 12 of the respective terminal devices 1 as a pixel.

### [c] Third Embodiment

FIG. 17 is a diagram for explaining markers 3a according to a third embodiment. As illustrated in FIG. 17, the marker to identify the location of the terminal device 1 may be, not only a radio beacon, a plate or the like placed for each certain location in the stadium 110, and may be the marker 3a placed for each seat 111, for example. In this marker 3a, on the upper surface, a seat number, a bar code, and others are indicated as the information that enables identifying the location of the seat 111.

The user of the terminal device 1 operates the camera 19 and photographs the marker 3a that is placed on the seat 111 at which the user is located. The locational-information acquiring unit 102 of the terminal device 1 reads, from the image of the marker 3a photographed by the camera 19, the information that enables identifying the location of the seat 111 such as the seat number and the bar code. The communication unit 101 transmits to the server 2 the information that has been read from the image of the marker 3a. Consequently, the server 2 can identify the location of the user (the location of the terminal device 1). Without using the camera 19, by entering the seat number to the terminal device 1 that the user himself/herself uses, the server 2 may identify the location of the terminal device 1 based on the seat number received from the terminal device 1.

### [d] Fourth Embodiment

FIG. 18 is an explanatory diagram illustrating one example of a choreography-creation aid system 100a according to a fourth embodiment. As illustrated in FIG. 18, in the choreography-creation aid system 100a, it is configured to perform display based on output values concerning the choreography, which are transmitted to the terminal device 1 from the server 2, on a display board 1a.

The display board la is arranged with indication lamps 12a such as light emitting diodes (LEDs) on one surface, and by an internal communication device (not depicted), performs radio communication with the terminal device 1 in BTLE standard and the like. In the display board 1a, the surface on which the indication lamps 12a are arranged is assumed to be sufficiently larger than the surface of the LCD 12 of the terminal device 1.

The terminal device 1 lights up, based on the output values from the server 2, the indication lamps 12a of the display board 1a by the radio communication. A user H who participates in choreography holds up the display board 1a on which the indication lamps 12a are lit up based on the output values from the server 2, and thereby reproduces a pixel of an image in the choreography. As just described, the choreography-creation aid system 100a enables the pixel of an image reproduced in choreography to be larger by using the display board 1a, as compared with when the LCD 12 of the terminal device 1 is used, and thereby carries out clearer choreography.

The respective constituent elements of the various devices illustrated in the drawings do not necessarily need to be physically configured as illustrated in the drawings. In other words, the specific embodiments of distribution or integration of the various devices are not limited to those illustrated, and the whole or a part thereof can be configured by being functionally or physically distributed or integrated in any unit, according to various types of loads and usage.

It does not matter if the server 2 is implemented as a cloud that provides the service of choreography creation aid by outsourcing, In the various processing units virtually implemented on the server 2, not all processing units need to foe in operation on the server 2 at ail times, and the processing units used for processing only need to be virtually implemented.

In the embodiments, the choreography that represents characters and images by regarding the terminal devices 1 of the users in the respective seats 111 as a pixel or a plurality of pixels has been exemplified. However, the form of the choreography is not limited to the foregoing. For example, the choreography to which the embodiments are applied may be the one that represents characters and images by the movement of users, such as waving of flags of the users who are located in the respective seats 111. In this choreography by the movement of users, the display unit 103 displays instructions transmitted from the server 2 on the LCD 12 of the terminal device 1. The respective users perform various movements based on the instructions displayed on the LCD 12 of the terminal devices 1. Consequently, the respective users of R (0, 0), R (0, 1), and so forth perform the movement such as waving of flags with the behavior content illustrated in FIG. 3 and carry out the choreography.

The programs executed by the server 2 do not necessarily need to be kept stored in the storage device 21 from the beginning. For example, the respective programs are stored in a “transportable physical medium” which is inserted into the server 2 and from which the data, thereof is read out, such as a flexible disk that is referred to as an FD, a CD-ROM, a DVD disk, a magneto-optical disk, and an IC card. The server 2 may be configured to acquire and execute the respective programs from these transportable physical media. The server 2 may further be configured, by storing the respective programs on other computer or server connected to the server 2 via a public line, the Internet, a LAN, a WAN, and the like, to acquire and execute the respective programs from these.

According to one embodiment of the invention, the choreography can be performed easily.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present, invention have been described in detail, it should be understood that the various changes, substitutions, and alterations could be made hereto without departing from the spirit and scope of the invention.

What is claimed is:

1. A choreography-creation aid method comprising:
receiving, from a terminal that is present in a certain area, information that enables identifying a location of the terminal;
determining, for each of sections obtained by dividing the certain area into two or more, whether a number of terminals that is calculated from the received information that enables identifying the location is greater than a certain number, by a processor; and
transmitting, to at least a part of terminals out of the terminals present in a first section for which the number of terminals is determined to be greater than the certain number, a request for moving to a second section for which the number of terminals is not determined to be greater than the certain number.

2. The choreography-creation aid method according to claim 1, further including accepting specifying of an image to be represented with a plurality of terminals present in the certain area in association with the certain area, wherein
the determining includes determining,, based on a location of presence of each of the terminals, an output value to a display of the respective terminals to represent the image and
the transmitting includes transmitting the output value determined for each of the terminals to the respective terminals.

3. The choreography-creation, aid method according to claim 2, wherein the transmitting includes transmitting an output value to represent the image by regarding a display of the display of the respective terminals as one or a plurality of pixels.

4. A choreography-creation aid method comprising:
receiving, from a terminal that is present in a certain area and includes a function of acquiring information concerning a current location, information that enables identifying a location of the terminal;
determining, for each of sections obtained by dividing the certain area into two or more, whether a number of terminals that is calculated from the received information that enables identifying the location is greater than a certain number, by a processor; and
outputting an alarm when a section for which the number of terminals is not determined to be greater than the certain number is present.

5. The choreography-creation aid method according to claim 4, further including accepting specifying of an image to be represented with a plurality of terminals present in the certain area in association with the certain area, by the processor, wherein
the determining includes determining, based on a location of presence of each of the terminals, an output value to a display of the respective terminals to represent the image, by the processor and.
the choreography-creation aid method further includes transmitting the output value determined for each of the terminals to the respective terminals.

6. The choreography-creation aid method according to claim 5, wherein the transmitting includes transmitting an output value to represent the image by regarding a display of the display of the respective terminals as one or a plurality of pixels.

7. A choreography-creation aid method comprising:
receiving, from a terminal that, is present in a certain area and includes a function of acquiring information concerning a current location, information that enables identifying a location of the terminal;
obtaining, based on the received information that enables identifying the location, the location of and a number of terminals present in the certain area, by a processor;
identifying, based on the obtained location of and number of terminals, one or more images to be an output target, by the processor; and
displaying the one or more identified images so as to be selectable.

8. The choreography-creation aid method according to claim 7, further including:
accepting specifying of an image to be represented with a plurality of terminals present in the certain area in association with the certain area, by the processor;
determining, based on a location of presence of each of the terminals, an output value to a display of the respective terminals to represent the image, by the processor; and
transmitting the output value determined for each of the terminals to the respective terminals.

9. The choreography-creation aid method according to claim 8, wherein the transmitting includes transmitting an output value to represent the image by regarding a display of the display of the respective terminals as one or a plurality of pixels.

10. An information processing apparatus comprising:
a processor that executes a process including:
receiving, from a terminal that is present in a certain area, information that enables identifying a location of the terminal;
determining, for each of sections obtained by dividing the certain area into two or more, whether a number of terminals that is calculated from the received information that enables identifying the location is greater than a certain number; and
transmitting, to at least a part of terminals out of the terminals present in a first section for which the number of terminals is determined to be greater than the certain number, a request for moving to a second section for which the number of terminals is not determined to be greater than the certain number.

11. An information processing apparatus comprising:
a processor that executes a process including:
receiving, from a terminal that is present in a certain area and includes a function of acquiring information concerning a current location, information that enables identifying a location of the terminal;
determining, for each of sections obtained by dividing the certain area into two or more, whether a number of terminals that is calculated from the received information that enables identifying the location is greater than a certain number; and
outputting an alarm when a section for which the number of terminals is not determined to be greater than the certain number is present.

12. An information processing apparatus comprising:
a processor that executes a process including:
receiving, from a terminal that is present in a certain area and includes a function of acquiring information concerning a current location, information that enables identifying a location of the terminal;
obtaining, based on the received information that enables identifying the location, the location of and a number of terminals present in the certain area;
identifying, based on the obtained location of and number of terminals, one or more images to be an output target; and
displaying the one or more identified images so as to be selectable.
